(19) United States
(12) Patent Application Publication
(10) Pub. No.: US 2012/0281155 A1
(43) Pub. Date: Nov. 8, 2012

(54) LIGHT SOURCE UNIT, LIGHTING DEVICE, DISPLAY DEVICE AND TELEVISION RECEIVER

(75) Inventor: Yuya Takano, Osaka-shi (JP)

(73) Assignee: SHARP KABUSHIKI KAISHA, Osaka-shi, Osaka (JP)

(21) Appl. No.: 13/576,163

(22) PCT Filed: Jan. 24, 2011
(86) PCT No.: PCT/JP2011/051175

§ 371 Date: Jul. 31, 2012

(30) Foreign Application Priority Data
Feb. 17, 2010 (JP) 2010-032750

(51) Int. Cl. F21V 9/08; H04N 3/10; G02F 1/13357; F21V 5/04; F21V 8/00

(52) U.S. Cl. 348/790; 362/231; 362/612; 349/69; 348/E03.011

(57) ABSTRACT

A light source unit in which color reproduction range is widened and uneven brightness and color unevenness are less likely to occur is provided. The light source unit includes light source sets 21 each of which includes a first light source 22 and a second light source, and an LED board 27 on which the sets 21 are arranged. The first source 22 includes a first LED chip 23 configured to emit at least a color of light of red, green or blue and phosphors excited by the light to emit light, colors of which are different from the color of the light from the chip 23. The second source 26 is configured to emit at least a color of light of cyan, magenta or yellow. The first source 22A in one of the adjacent sets and the second source 26B in another one of the adjacent sets are arranged adjacent to each other in an arrangement direction in which the adjacent sets are arranged.

### TECHNICAL FIELD

The present invention relates to a light source unit, a lighting device, a display device and a television receiver.

### BACKGROUND ART

In recent years, a type of an image display device including a television receiver has been shifted from a conventional CRT display device to a thin display device using a thin display element such as a liquid crystal panel and a plasma display. An image display device disclosed in Patent Document 1 has been known. The image display device includes a liquid crystal panel that includes a color filter and a lighting device that is configured to illuminate the liquid crystal panel with light. The lighting device includes a unit (light source unit) that is configured with a base board and a plurality of LEDs arranged on the base board. The lighting device illuminates the liquid crystal panel with light and the light transmits through the liquid crystal panel and subsequently passes through the color filter. The color filter includes color sections, and only the light having certain wavelengths corresponding to each of the color sections selectively passes through the color filter. With such a configuration, various colors of light can be reproduced according to combinations of light passing through each of the coloring portions.

Patent Document 1: Japanese Unexamined Patent Publication No. 2005-352452

### PROBLEM TO BE SOLVED BY THE INVENTION

To achieve high display quality of the image display device, high color reproduction is required. In the image display device disclosed in Patent Document 1, the color filter includes a cyan color portion in addition to color sections of primary colors including red, green and blue. In the above configuration, color variations of the color sections are added to achieve high display quality of the image display device. It may be also effective to increase a color reproduction range in the light exited from the lighting device (light exited from the light source unit) and improvement can be made in this point.

### DISCLOSURE OF THE PRESENT INVENTION

The present invention was accomplished in view of the above circumstances. It is an object of the present invention to provide a light source unit in which wide color reproduction range is achieved and uneven brightness and color unevenness are less likely to occur. Another object of the present invention is to provide a lighting device, a display device and a television receiver having the light source unit.

### Means for Solving the Problem

To solve the above problem, a light source unit according to the present invention includes a board and a plurality of light source sets arranged on the board and each of which including a first light source and a second light source. The first light source includes a first LED chip and a phosphor. The first LED chip is configured to emit at least a single color of light of red, green or blue and the phosphor is configured to be excited by the light from the first LED chip to emit light, and colors of the emitted light are different from the color of the light emitted from the first LED chip. The second light source is configured to emit at least a single color of light of cyan, magenta or yellow. At least two of the light source sets that are adjacent to each other are arranged such that the first light source in one of the adjacent light source sets and the second light source in another one of the adjacent light source sets are arranged adjacent to each other in an arrangement direction in which the adjacent light source sets are arranged.

In the light source unit according to the present invention, the first light source and the second light source are included in the light source set. Therefore, wide color reproduction range is achieved compared to a configuration where only the first light source is included in the light source set. In such a configuration of the LED unit including a plurality of light source sets 21 each of which has the first light source 22 and the second light source 26, if two adjacent light source sets are arranged such that the first light source of one of the light source sets is are arranged adjacent to the first light source of another one of the light source sets in the arrangement direction of the two adjacent light source sets, the first light sources are arranged locally (locally in a concentrated manner) on the board. This may cause uneven brightness or color unevenness. According to the present invention, the first light source in one of the adjacent light source sets and the second light source in another one of the adjacent light source sets are arranged adjacent to each other in an arrangement direction in which the adjacent light source sets are arranged. With such a configuration, the first light sources are less likely to be arranged locally on the board, and thus uneven brightness and color unevenness are less likely to occur.

In the light source unit, the first light source and the second light source in each of the light source sets are arranged on the board in a direction that crosses the arrangement direction of the light source sets.

In the light source unit, the first light source may be configured by sealing the first LED chip with a resin material, and the phosphor may be contained in the resin material in a dispersed manner. The phosphor content is appropriately controlled, and thus the ratio between light from the first light source and light emitted by the phosphors excited therefrom varies. Therefore, the chromaticity of light from the first light source is controlled.

In the light source unit, the first LED chip may be a blue LED chip configured to emit blue light. The phosphor may include a red phosphor excited by light from the first LED chip to emit red light and a green phosphor excited by light from the first LED chip to emit green light. With such a configuration, substantially white light (including white light and substantially white light with a blue tinge) can be emitted from the first light source. Moreover, the chromaticity of light of the second light source is controlled. Accordingly, the chromaticity of light per the light source set can be controlled. If the first light source emits white light with a blue tinge, an LED configured to emit yellow light is used for the second light source. This allows the light source set to exit light that is closer to white light.

In the light source unit, the red phosphor may be a CASN phosphor. A CASN phosphor that is a nitride phosphor is used as a red phosphor. With such a configuration, the CASN phosphor is allowed to emit red light with high efficiency compared to a configuration of using sulfide phosphors and oxide phosphors.

In the light source unit, the green phosphor may be a SiAlON-based phosphor. A SiAlON-based phosphor that is a nitride phosphor is used as a green phosphor. With such a configuration, the SiAlON-based phosphor is allowed to emit green light with high efficiency compared to sulfide phosphors and oxide phosphors. In addition, light emitted from a SiAlON-based phosphor has color purity higher than a YAG phosphor, for example. Therefore, the chromaticity of light can be easily controlled.

In the light source unit, the green phosphor may be a YAG-based phosphor.

The light source unit may further include a diffuser lens. The first light source may include a light emitting surface and the second light source may include alight emitting surface. The diffuser lens may be provided so as to cover at least one of the light emitting surfaces of the first light source and the second light source and configured to diffuse light from at least the one of the light emitting surfaces thereof. Light from the first light source or the second light source is diffused by the diffuser lens. This causes arrangement intervals between the light source sets to be increased (namely, the total number of light source sets is reduced) and achieves uniform brightness.

Next, to solve the above problem, a lighting device may include the light source unit and a housing member housing the light source unit.

The lighting device may further include a light guide plate including a light entrance surface and a light exit surface. The light entrance surface may face the light emitting surface of the first light source and the light emitting surface of the second light source. Light exited from the emitting surfaces of the light sources may enter the light entrance surface and may exit from the light exit surface.

Next, to solve the above problem, a display device according to the present invention may include the above lighting device and a display panel configured to provide display using light from the lighting device.

The display panel may be a liquid crystal panel. The display device as a liquid crystal display device has a variety of applications, such as a television display or a personal-computer display. Particularly, it is suitable for a large screen display.

Next, to solve the above problem, a television receiver according to the present invention may include the above display device.

### Advantageous Effect of the Invention

According to the present invention, a light source unit that achieves wide color reproduction range and in which uneven brightness and color unevenness are less likely to occur, a lighting device, a display device and a television receiver including the light source unit are provided.

### BRIEF DESCRIPTION OF THE DRAWINGS

FIG. 1 is an exploded perspective view illustrating a general configuration of a television receiver according to a first embodiment of the present invention;

FIG. 2 is an exploded perspective view illustrating a general configuration of a liquid crystal display device included in the television receiver in FIG. 1;

FIG. 3 is a cross-sectional view illustrating a sectional configuration taken along a short side of the liquid crystal display device in FIG. 2;

FIG. 4 is a plan view illustrating a light source unit included in the liquid crystal display device in FIG. 2;

FIG. 5 is an exploded perspective view illustrating a general configuration of a liquid crystal display device according to a second embodiment of the present invention;

FIG. 6 is a cross-sectional view illustrating a sectional configuration taken along a short side of the liquid crystal display device in FIG. 5;

FIG. 7 is a plan view illustrating a light source unit included in the liquid crystal display device in FIG. 5; and

FIG. 8 is a plan view illustrating a light source unit according to a third embodiment of the present invention.

### BEST MODE FOR CARRYING OUT THE INVENTION

### First Embodiment

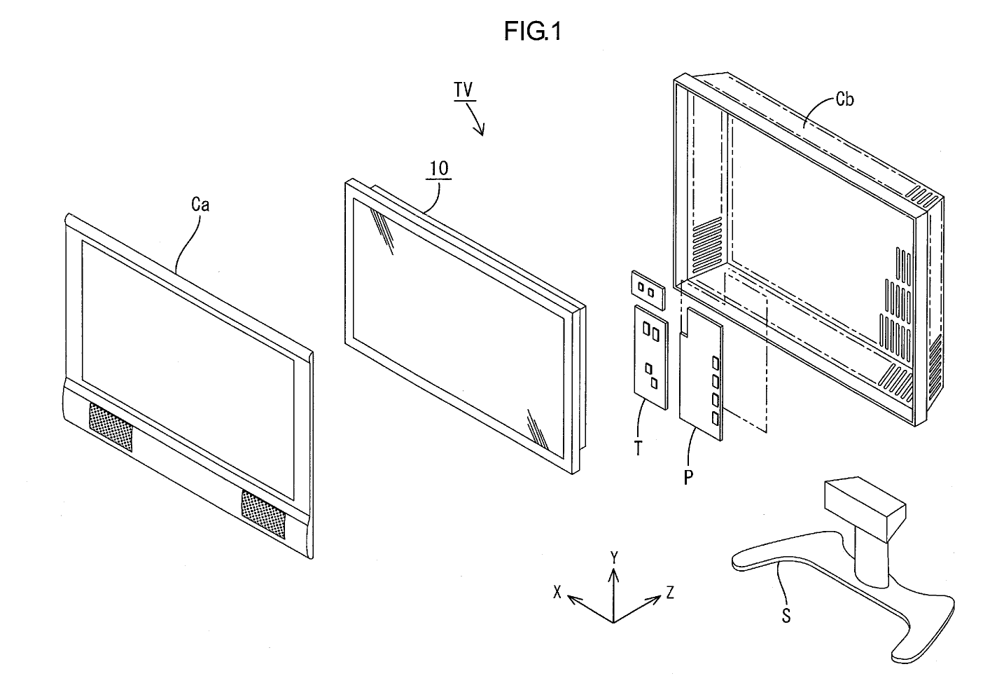

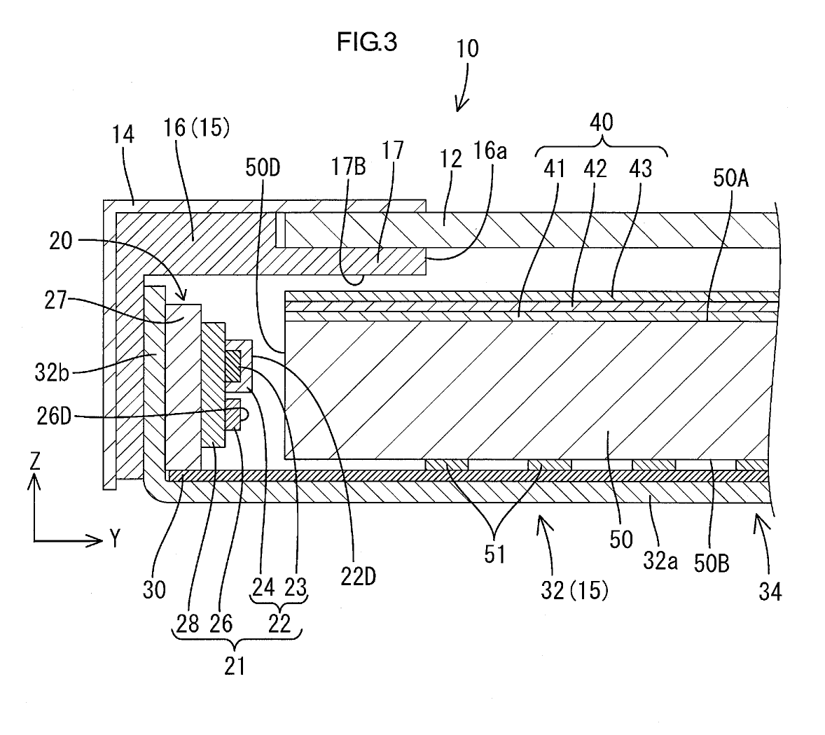

A first embodiment according to the present invention will be described with reference to FIGS. 1 to 4. An X axis, a Y-axis and a Z-axis are described in a part of the drawings, and a direction of each axial direction corresponds to a direction described in each drawing. An upper side in FIG. 3 corresponds to a front-surface side and a lower side in FIG. 3 corresponds to a rear-surface side.

As illustrated in FIG. 1, the television receiver TV of the present embodiment includes the liquid crystal display device 10, front and rear cabinets Ca, Cb which house the liquid crystal display device 10 therebetween, a power source P, a tuner T and a stand S.

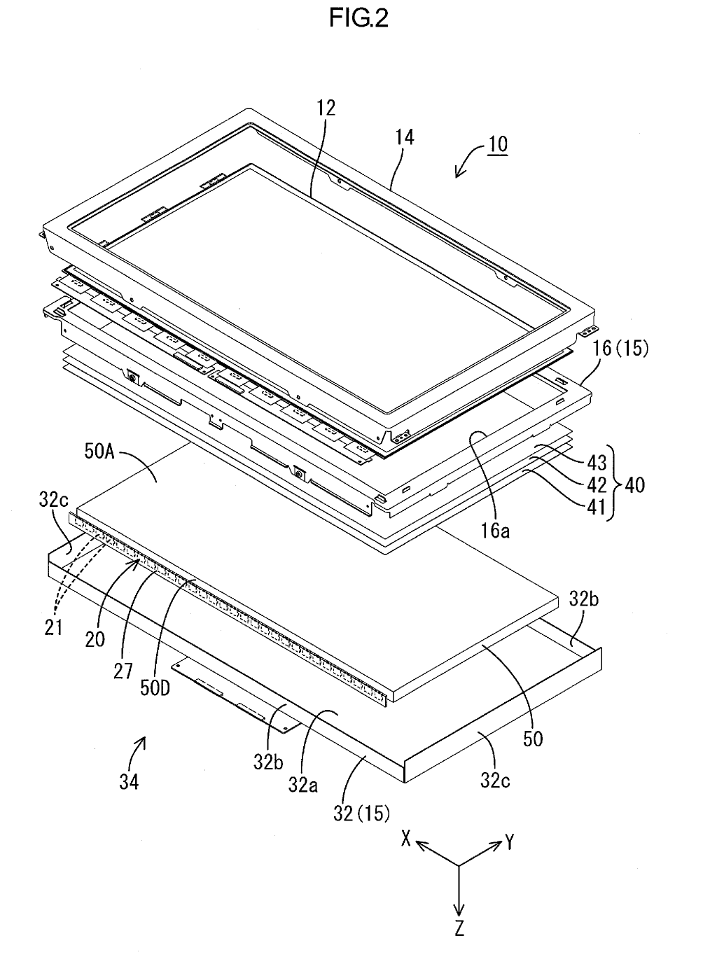

FIG. 2 illustrates an exploded perspective view of the liquid crystal display device 10. An upper side in FIG. 2 corresponds to a front-surface side and a lower side in FIG. 2 corresponds to a rear-surface side. An entire shape of the liquid crystal display device 10 is a landscape rectangular. As illustrated in FIG. 2, the liquid crystal display device 10 includes a liquid crystal panel 12 as a display panel, and a backlight unit 34 as an external light source. The liquid crystal panel 12 and the backlight unit 34 are integrally held by a frame shaped bezel 14 and the like.

As illustrated in FIG. 2, the liquid crystal panel 12 included in the liquid crystal display device 10 is formed in a rectangular plan view shape. A long-side direction of the liquid crystal panel 12 matches a horizontal direction (an X-axis direction) and a short-side direction thereof matches a vertical direction (a Y-axis direction). The liquid crystal panel 12 is configured such that a pair of transparent glass substrates (highly capable of light transmission) is bonded together with a predetermined gap therebetween and liquid crystal is sealed between the glass substrates. On one of the glass substrates, switching components (for example, TFTs) connected to source lines and gate lines which are perpendicular to each other, pixel electrodes connected to the switching components, and an alignment film and the like are provided. On the other substrate, color filters having color sections such as R (red), G (green) and B (blue) color sections arranged in a predetermined pattern, counter electrodes, and an alignment film and the like are provided. A drive circuit board (not shown) supplies image data and various control signals that are necessary to display images to the source lines, the gate lines and the counter electrodes. Polarizing plates (not shown) are attached to outer surfaces of the substrates.

The backlight unit 34 will be described. As illustrated in FIG. 2, the backlight unit 34 includes a housing member 15 including a backlight chassis 32 and a front chassis 16. The housing member 15 houses an LED unit 20, a light guide plate 50, and an optical member 40 therein. The backlight unit 34 according to the present embodiment is an edge-light-type (side-light-type) backlight unit in which the light guide plate 50 is arranged right behind the liquid crystal panel 12 and an LED unit 20 including a light source set 21 (described later) is arranged on a side end portion of the light guide plate 50 (a side end portion of the housing member 15).

The substantially box-shaped backlight chassis 32 has an opening on the front-surface side (on the light exit side and the liquid crystal panel 12 side). The optical member 40 is arranged so as to cover the opening of the backlight chassis 32. The front chassis 16 has a rectangular frame shape having an opening 16a through which the optical member 40 is exposed to the front side. The front chassis 16 is provided so as to enclose the optical member 40. As illustrated in FIG. 3, on an inner peripheral end portion of the front chassis 16, a stepped portion 17 is provided. A peripheral edge portion of the liquid crystal panel 12 is placed on the stepped portion 17. With this configuration, the light exiting from the light guide plate 50 passes through the optical member 40, and then is applied to a rear surface of the liquid crystal panel 12 through the opening 16a.

The backlight chassis 32 is made of metal such as aluminum material, for example. The backlight chassis 32 includes the bottom plate 32a and the side plates 32b and 32c each of which rises shallowly from an outer edge of the corresponding side of the bottom plate 32a toward the front surface side. The bottom plate 32a is formed in a rectangular plan view shape. A long-side direction of the bottom plate 32a matches a horizontal direction (an X-axis direction) and a short-side direction thereof matches a vertical direction (a Y-axis direction). A power supply circuit board (not shown) configured to supply power to the LED unit 20 is mounted on the rear side of the bottom plate 32a.

The light guide plate 50 formed in a plate member having a rectangular plan view shape and is elongated in the long side direction (X-axis direction) of the backlight chassis 32. The light guide plate 50 is made from a resin (such as acrylic) highly capable of light transmission (or with high transparency). As illustrated in FIG. 3, the light guide plate 50 is arranged such that a main plate surface (a light exit surface 50A) thereof faces toward the liquid crystal panel 12 and one of side surfaces (a light entrance surface 50D) faces a light emitting surface 22D of a first light source 22 and a light emitting surface 26D of a second light source 26. The light guide plate 50 is not limited to be formed in a rectangular plan view shape and may be formed in any other shapes.

As illustrated in FIG. 3, a plurality of light reflective portions 51 are provided on a surface 50B (a rear surface 50B) of the light guide plate 50 that is opposite from the light exit surface 50A. The light reflective portions 51 are arranged in a dotted pattern having a white color. The light reflective portions 51 are configured to reflect and scatter the light. Accordingly, some of the rays of light that travel toward the light exit surface 50A after being reflected and scattered by the light reflective portions 51 has an entrance angle that is not above the critical angle (some of the rays of light are not totally reflected), and thus the light can exit toward the liquid crystal panel 12 through the light exit surface 50A. The light reflective portions 51 are, for example, configured by arranging the dots in a zigzag pattern (grid pattern, staggered pattern). The dots are formed by printing metal oxide pastes on the rear surface 50B of the light guide plate 50, for example. Preferable examples of the printing method of the dots include screen printing and ink-jet printing.

With the above configuration, the light exited from (each light source set 21 of) the LED unit 20 enters the light guide plate 50 through the light entrance surface 50D of the light guide plate 50, and then is guided within the light guide plate 50 due to the total reflection and is reflected and scattered by the light reflective portion 51. Thus, the light exits from the light exit surface 50A. Then, the light exiting from the light exit surface 50A is applied to the rear surface of the liquid crystal panel 12 after passing through the optical member 40. The light reflective portions 51 are provided on an area corresponding to the opening 16a of the front chassis 16 (an area overlapping with the opening 16a in a plan view), for example.

As illustrated in FIG. 3, a light reflection sheet 30 is arranged on the bottom plate 32a of the backlight chassis 32. The light reflection sheet 30 is formed in a rectangular plan view shape. The light reflection sheet 30 is arranged so as to cover almost entire of the rear surface 50B of the light guide plate 50 and a rear surface of the LED unit 20. The light reflection sheet 30 is made of a synthetic resin, for example, and includes a front surface having a white color that provides high light reflectivity. The light exiting from the light guide plate 50 to the light reflective sheet 30 is reflected again toward the light exit surface 50A by the light reflective sheet 30. This improves light use efficiency. The light reflection sheet 30 also has a function of reflecting the light that is exited from the LED unit 20 to the light reflection sheet 30 so as to enter the light entrance surface 50D of the light guide plate 50. The material and color, for example, of the light reflection sheet 30 are not limited to those of the present embodiment. Any light reflective sheets that can reflect the light may be used.

As illustrated in FIG. 3, the optical member 40 is arranged so as to cover the front surface of the light exit surface 50A of the light guide plate 50. The optical member 40 includes a light diffuser sheet 41, a prism sheet 42, and a reflection-type polarizing sheet 43 arranged in this sequence from the light exit surface 50A side. The light diffuser sheet 41 may be configured by bonding a diffusion layer including light scattering particles dispersed therein onto a front surface of a light transmissive board made of synthetic resin. The light diffuser sheet 41 diffuses the light that exits from the light exit surface 50A. The prism sheet 42 controls the traveling direction of the light that passed through the light diffuser sheet 41.

The reflection-type polarizing sheet 43 has a multilayer structure in which layers having different reflective indexes are alternately arranged, for example. The reflection-type polarizing sheet 43 transmits p-wave of the light exiting through the light exit surface 50A and reflects s-wave toward the light guide plate 50. The s-wave reflected by the reflection-type polarizing sheet 43 is reflected again toward the front side by the light reflection sheet 30, for example. At this time, the reflected s-wave separates into s-wave and p-wave. As described above, the reflection-type polarizing sheet 43 allows the s-wave that is normally absorbed by the polarizing plate of the liquid crystal panel 12 to be reused by reflecting the s-wave toward the light guide plate side. This improves light use efficiency (and thus brightness). An example of the reflection-type polarizing sheet 43 is a product named “DBEF” that is manufactured by Sumitomo 3M Limited.

As illustrated in FIG. 2, like the light guide plate 50, each of the light diffuser sheet 41, the prism sheet 42, and the reflection-type polarizing sheet 43 has a rectangular shape extending along the X-axis direction in a plan view. The light diffuser sheet 41, the prism sheet 42, and the reflection-type polarizing sheet 43 have the same shape. The sheets 41 to 43 are arranged so as to cover the front surface of the light exit surface 50A of the light guide plate 50. The shape of the sheets 41 to 43 included in the optical member 40 is not limited to the rectangular shape in a plan view. The sheets 41 to 43 included in the optical member 40 may be arranged so as to cover at least part of the front surface of the light exit surface 50A of the light guide plate 50.

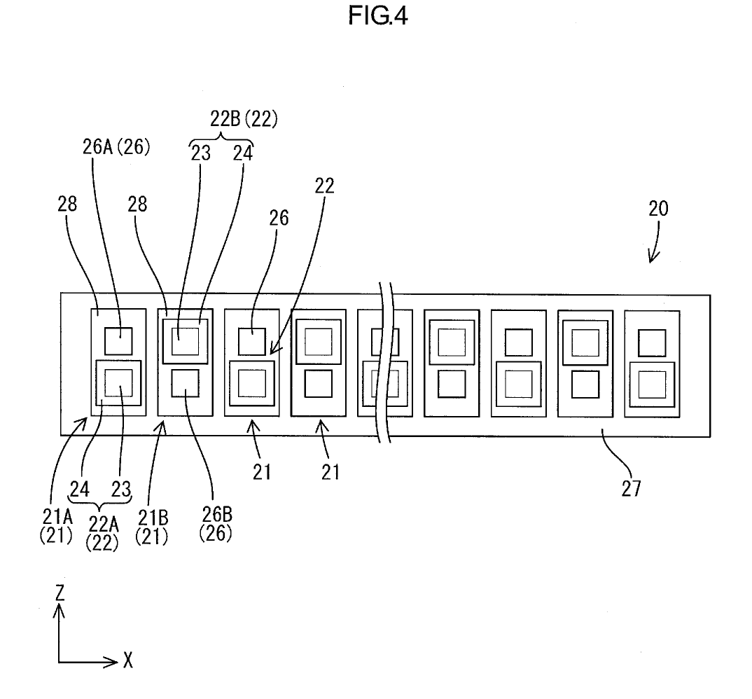

Next, the configuration of the LED unit 20 (the light source unit) will be explained in detail. As illustrated in FIGS. 2 and 3, the LED unit 20 is attached to an inner surface of one of the side plates 32b with screws, for example. The side plates 32b extend in the long-side direction (X-axis direction) of the backlight chassis 32. The LED unit 20 includes a plurality of light source sets 21 and an LED board 27 on which the light source sets 21 are arranged as illustrated in FIG. 4. The LED board 27 is formed in a rectangular shape extending in the X-axis direction. The light source sets 21 are arranged in a line in the X-axis direction.

As illustrated in FIGS. 3 and 4, each light source set 21 includes a base 28, a first light source 22 and a second light source 26. The first light source 22 and the second light source 26 are mounted on the base 28 formed in a rectangular plate shape extending in the Z-axis direction. The first light source 22 and the second light source 26 are provided in each light source set 21, and arranged in a direction (Z-axis direction) that is perpendicular to an arrangement direction (X-axis direction) in which the light source sets 21 are arranged on the LED board 27 (on the X-Z plane). On the LED board 27 (X-Z plane), the first light source 22 and the second light source 26 in each light source set 21 are not necessarily to be arranged in the direction perpendicular to the arrangement direction of the light source sets 21 but may be arranged in a direction that crosses the arrangement direction (the X-axis direction) of the light source sets 21.

In the present embodiment, the first light sources 22 that are arranged close to an upper side in FIG. 4 and the first light sources 22 that are arranged close to a lower side in FIG. 4 are provided alternately in the X-axis direction. The second light sources 26 that are arranged close to the upper side in FIG. 4 and the second light sources 26 that are arranged close to the lower side in FIG. 4 are provided alternately in the X-axis direction. Accordingly, the first light sources 22 (or the second light sources 26) of the light source sets 21 are arranged non-linearly (in substantially a zigzag line).

Two adjacent light source sets 21 (21A and 21B) are arranged such that the arrangement of the light sources 22, 26 of the light source set 21 (21A) is inverted from the arrangement of the light sources 22, 26 of the light source set 21 (21B). Specifically, the first light source 22 (22A) in one of the light source sets 21 (21A) and the second light source 26 (26B) in the other one of the light source sets 21 (21B) are arranged adjacent to each other in the X-axis direction (in the arrangement direction in which the two adjacent light source sets 21 are arranged). The second light source 26 (26A) in one of the light source sets 21 (21A) and the first light source 22 (22B) in the other one of the light source sets 21 (21B) are arranged adjacent to each other in the X-axis direction (in the arrangement direction of the two adjacent light source sets 21). This arrangement configuration of the light sources 22 and 26 may not be applied to all adjacent light source sets 21 arranged on the LED board 27, and may be applied to at least two adjacent light source sets 21 arranged thereon.

The first light source 22 is configured by sealing a first LED chip 23 with a transparent resin material 24 (silicone resin), for example. In other words, the first LED chip 23 is covered with the resin material 24. The first LED chip 23 is configured to emit at least a single color of light of red, green or blue. In the present embodiment, a blue LED chip configured to emit blue light is used. The blue LED chip has a main light emitting peak in a blue wavelength range that is from 430 nm to 500 nm. The blue LED chip can emit pure blue light.

Phosphors are contained in the resin material 24 in a dispersed manner. The phosphors are excited by light from the first LED chip 23 to emit light, the colors of which are different from the color of the light emitted from the first LED chip 23. In the present embodiment, for example, green phosphors and red phosphors are contained in the resin material 24 at a certain rate in a dispersed manner. The green phosphors are excited by blue light emitted from the first LED chip 23 to emit green light. The red phosphors are excited by blue light emitted from the first LED chip 23 to emit red light.

Blue light (light including a blue component) is emitted from the first LED chip 23. Green light (light including a green component) is emitted from green phosphors. Red light (light including a red component) is emitted from red phosphors. Accordingly, the first light source 22 emits substantially white light (including white light and substantially white light with a blue tinge). In addition, yellow light is obtained by mixture of light having a green component from green phosphors and light having a red component from red phosphors, and accordingly, the phosphors contained in the resin material 24 are excited by light from the first LED chip 23 to emit light having a yellow component. Instead of the configuration provided with the green phosphors and the red phosphors, phosphors (for example, YAG phosphors) that emit yellow light by excitation by blue light may be provided.

Chromaticity of the first light source 22 varies depending on the absolute or relative amount of green phosphors and red phosphors contained in the resin material 24. The amount of green phosphors and red phosphors can be controlled as appropriate, and therefore the chromaticity of the first light source 22 (and thus the light source set 21) can be controlled. In the present embodiment, the green phosphor has a main light emitting peak in a green wavelength range that is from 500 nm to 570 nm, for example. The red phosphor has a main light emitting peak in a red wavelength range that is from 610 nm to 780 nm, for example.

The green phosphor and the red phosphor will be further explained in detail. For example, a β-SiAlON phosphor of a SiAlON-based phosphor, which is a nitride, is preferably used as a green phosphor. The β-SiAlON phosphor emits green light with high efficiency compared to sulfide phosphors and oxide phosphors and the emitted green light contains especially highly chromatic purity of a green color. Therefore, the β-SiAlON phosphor is very useful for controlling the chromaticity of the first light source 22. Specifically, Eu (europium) is used as an activator for the β-SiAlON phosphor. The general formula thereof is expressed as Si6-zAlzOzN8-z:Eu (z shows the amount of solid solution) or (Si,Al)6(O,N)8:Eu.

The green phosphor may be another phosphor other than the above β-SiAlON phosphor and altered if necessary. (Y,Gd)3Al5O12:Ce of a YAG-based phosphor is preferable to be used as the green phosphor because light emission with high efficiency is achieved. Examples of the green phosphor include the following inorganic phosphors: (Ba,Mg)Al10O17:Eu,Mn; SrAl2O4:Eu; Ba1.5Sr0.5SiO4:Eu; BaMgAl10O17:Eu,Mn; Ca3(Sc,Mg)2Si3O12:Ce; Lu3A15O12:Ce; CaSc2O4:Ce; ZnS:Cu,Al; (Zn,Cd)S:Cu,Al; Y3Al5O12:Tb; Y3(Al,Ga)5O12:Tb; Y2SiO5:Tb; Zn2SiO4:Mn; (Zn,Cd)S:Cu; ZnS:Cu; Gd2O2S:Tb; (Zn,Cd)S:Ag; Y2O2S:Tb; (Zn,Mn)2SiO4; BaAl12O19:Mn; (Ba,Sr,Mg)O.aAl2O3:Mn; LaPO4:Ce,Tb; Zn2SiO4:Mn; CeMgAl11O19:Tb; and BaMgAl10O17:Eu,Mn.

For example, a CaAlSiN₃-based phosphor, commonly known as a CASN phosphor in the CASN system, which is a nitride, is preferably used as a red phosphor. The CASN phosphor is allowed to emit red light with high efficiency compared to sulfide phosphors and oxide phosphors. Specifically, Eu (europium) is used as an activator for the CASN phosphor, which is expressed as CaAlSiN3:Eu. The red phosphor may be another phosphor other than the above CASN phosphor and altered if necessary. Moreover, examples of the red phosphors include the following inorganic phosphors: (Sr,Ca)AlSiN3:Eu; Y2O2S:Eu; Y2O3:Eu; Zn3(PO4)2:Mn; (Y,Gd,Eu)BO3; (Y,Gd,Eu)2O3; YVO4:Eu; and La2O2S:Eu,Sm.

The second light source 26 is configured to emit at least a single color of light of cyan, yellow or magenta. In the present embodiment, an LED configured to emit yellow light is used, for example. The “LED” here may include at least an LED chip therein. The following configurations are applicable to the second light source 26: an LED chip configured to emit yellow (cyan or magenta) light; LED chips in combination configured to emit yellow (cyan or magenta) light; and an LED chip and phosphors configured to emit yellow (cyan or magenta) light.

The first light sources 22 and the second light sources 26 are arranged such that light axes thereof extend in a direction parallel to a display surface of the liquid crystal panel 12 or a light exit surface 50A of the light guide plate (Y-axis direction). As illustrated in FIG. 3, a light emitting surface 22D of the first light source 22 and a light emitting surface 26D of the second light source 26 face a side surface (light entrance surface 50D) of the light guide plate 50.

The LED board 27 is made of synthetic resin. A front surface (a surface facing the light guide plate 50) of the LED board 27 have a white color that provides high light reflectivity. With such a configuration, light reflects off the front surface of the LED board 27 to the light guide plate. Therefore, light use efficiency is improved.

As illustrated in FIG. 2, the LED board 27 has a rectangular plate shape extending in the X-axis direction. The long side of the LED board 24 is slightly shorter than (or substantially the same as) that of the bottom plate 32a. Further, mounting holes (not illustrated) that are through holes are formed in the bottom plate 32a to fix the LED board 24 with screws.

A wiring pattern (not illustrated) made of metal film is provided on the LED board 27 and the first light sources 22 (the first LED chip 23) and the second light sources 26 are electrically connected to the wiring pattern. A control board, which is not illustrated, is connected to the LED board 27. The control board supplies the power required to turn on the first light sources 22 and the second light sources 26 and controls the drive of the first light sources 22 and the second light sources 26.

Next, effects in the present embodiment will be explained. The LED unit 20 of the present embodiment includes the light source sets 21 and the LED board 27 on which the light source sets 21 are arranged. Each of the light source sets 21 includes the first light source 22 and the second light source 26. The first light source 22 includes the first LED chip 23 and phosphors. The first LED chip 23 is configured to emit at least a single color of light of red, green or blue. The phosphors are excited by light from the first LED chip 23 to emit light, colors of which are different from the color of the light emitted from the first LED chip 23. The second light source 26 is configured to emit at least a single color of light of cyan, magenta or yellow. The two adjacent light source sets 21A and 21B are arranged such that the first light source 22A of the light source set 21A and the second light source 26B of the light source set 21B are arranged adjacent to each other in the X-axis direction (in the arrangement direction in which the two adjacent light source sets 21A and 21B are arranged).

In the LED unit 20 of the present embodiment, each of the light source sets 21 includes the first light source 22 and the second light source 26. With such a configuration, the color reproduction range is widened compared to a configuration in which only the first light sources 22 are provided. In such a configuration of the LED unit including a plurality of light source sets 21 each of which has the first light source 22 and the second light source 26, if the two adjacent light source sets (21A, 21B) are arranged such that the first light source 22A of the light source set 21A is arranged adjacent to the first light source 22B of the light source set 21B in the arrangement direction (in the X-axis direction) of the two adjacent light source sets 21A and 21B, the first light sources 22A and 22B (or the second light sources 26A and 26B) are locally arranged on the LED board 27. This may cause uneven brightness or color unevenness.

For example, the first light sources 22 (22A and 22B) are arranged on one side of the LED unit 20 (on an upper side of FIG. 4) and the second light sources 26 (26A and 26B) are arranged on another side thereof (on a lower side of FIG. 4). With such a configuration, light from the first light sources 22 mainly exits from the one side of the LED unit 20, and light from the second light sources 26 mainly exits from the another side thereof. Accordingly, different types of light exits from the one side of the LED unit 20 and from the another side thereof, and thus uneven brightness or color unevenness is likely to occur.

In the present embodiment, the two adjacent light source sets 21A and 21B are arranged such that the first light source 22A of the light source set 21A and the second light source 26B of the light source set 21B are arranged adjacent to each other in the arrangement direction of the two adjacent light source sets 21A and 21B. With such a configuration, the first light sources 22 (or the second light sources 26) are less likely to be arranged locally on the LED board 27, thereby reducing uneven brightness and color unevenness in the light exiting from the LED unit 20.

In the LED unit 20, the first light source 22 and the second light source 26 of each light source set 21 are arranged on the LED board 27 in a direction (the Z-axis direction in the present embodiment) that crosses the arrangement direction of the light source sets 21.

The first light source 22 is configured by sealing the first LED chip 23 with the resin material 24. The phosphors are contained in the resin material 24 in a dispersed manner. The phosphor content is appropriately controlled, and thus the ratio between light from the first light source 22 and light emitted by the phosphors excited therefrom varies. Therefore, the chromaticity of light from the first light source 22 is controlled.

The first LED chip 23 is a blue LED chip configured to emit blue light. The phosphors include a red phosphor and a green phosphor. The red phosphor is excited by light from the first LED chip 23 to emit red light. The green phosphor is excited by light from the first LED chip 23 to emit green light. With such a configuration, substantially white light (including white light and substantially white light with a blue tinge) can be emitted from the first light source 22. Moreover, the chromaticity of light from the second light source 26 is controlled, and thus the chromaticity of light exited from the light source set 21 is controlled.

If the first light source 22 emits white light with a blue tinge, an LED configured to emit yellow light that is a complementary color of blue is used for the second light source 26. This allows the light source set 21 to emit light that is closer to white light. Moreover, if the first light source 22 emits white light with a green tinge, an LED configured to emit magenta light that is a complementary color of green is used for the second light source 26. This allows the light source set 21 to emit light that is closer to white light. The color combination of light of the first light source 22 and the second light source 26 may be altered if necessary.

The red phosphor is a CASN phosphor. A CASN phosphor that is a nitride phosphor is used as a red phosphor. The CASN phosphor is allowed to emit red light with high efficiency compared to sulfide phosphors and oxide phosphors.

The green phosphor is a SiAlON-based phosphor. A SiAlON-based phosphor that is a nitride is used as a green phosphor. The SiAlON-based phosphor is allowed to emit green light with high efficiency compared to sulfide phosphors and oxide phosphors. In addition, light emitted from the SiAlON-based phosphor has color purity higher than a YAG phosphor, for example. Therefore, the chromaticity can be controlled easily.

The green phosphor may be a YAG-based phosphor.

Next, the backlight unit 34 of the present embodiment includes the LED unit 20 and the housing member 15 that houses the LED unit 20.

The backlight unit 34 includes the light guide plate 50 that includes the light entrance surface 50D and the light exit surface 50A. The light entrance surface 50D faces the light emitting surface 22D of the first light source 22 and the light emitting surface 26D of the second light source 26. Light from the light emitting surfaces 22D and 26D enters the light guide plate 50 through the light entrance surface 50D and exits from the light guide plate 50 through the light exit surface 50A.

In the present embodiment, the LED unit 20 in which wide color reproduction range is achieved is provided. Furthermore, the backlight unit 34, the liquid crystal display 10 and the television receiver TV including the LED unit 20 are provided.

### Second Embodiment

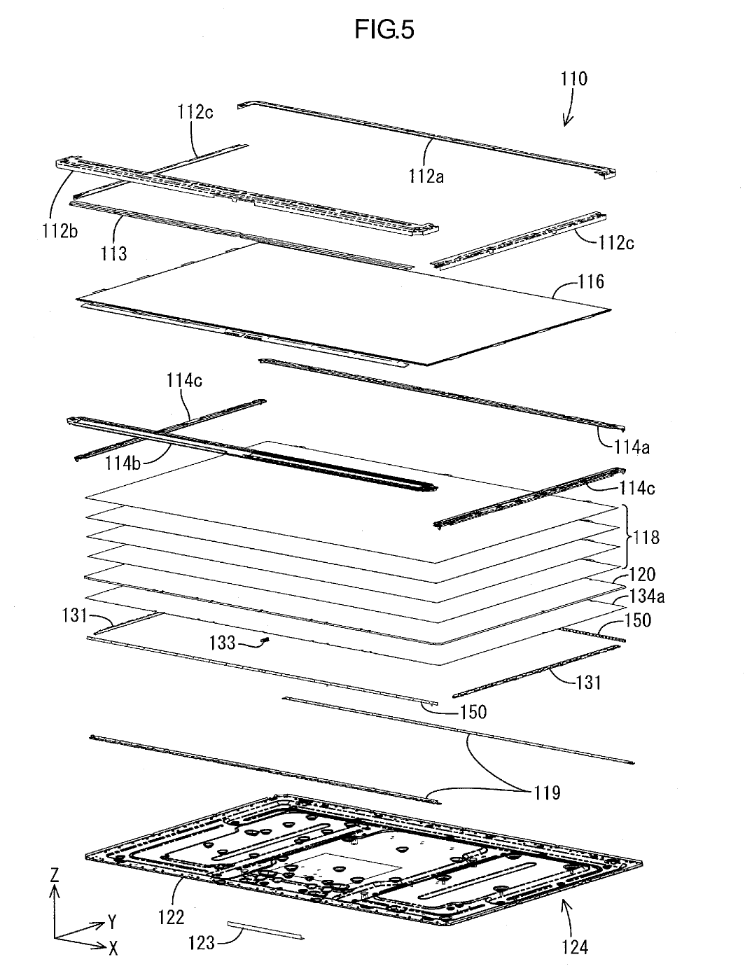

A second embodiment according to the present invention will be explained with reference to FIGS. 5 to 7. In the second embodiment, a liquid crystal display device 110 includes components different from the first embodiment. The construction, operations and effects as same as the first embodiment will not be explained.

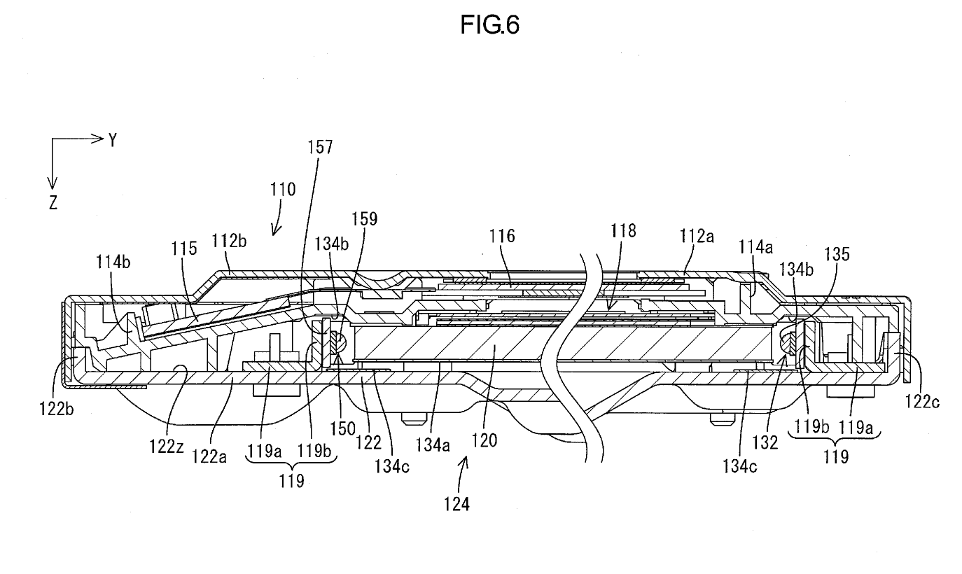

FIG. 5 illustrates an exploded perspective view of the liquid crystal display device 110 according to the present embodiment. An upper side in FIGS. 5 and 6 corresponds to a front-surface side and a lower side in FIGS. 5 and 6 corresponds to a rear-surface side. An entire shape of the liquid crystal display device 110 is a landscape rectangular. As illustrated in FIG. 5, the liquid crystal display device 110 includes a liquid crystal panel 116 as a display panel, and a backlight unit 124 as an external light source. The liquid crystal panel 116 and the backlight unit 124 are integrally held by a top bezel 112a, a bottom bezel 112b, side bezels 112c (hereinafter a bezel set 112a to 112c) and the like. The construction of the liquid crystal panel 116 that is as same as the first embodiment will not be explained.

In the following, the backlight unit 124 will be explained. The backlight unit 124 is a so-called edge-light-type (side-light-type) backlight unit like the first embodiment. However, the configuration is different from the first embodiment in that the LED units 150 are arranged on both side end portions of the light guide plate 120. As illustrated in FIG. 5, the backlight unit 124 includes a backlight chassis 122, optical members 118, a top frame 114a, a bottom frame 114b, side frames 114c and a light guide plate reflection sheet 134a. In the following, the top frame 114a, the bottom frame 114b, and the side frames 114c are referred to as a frame set 114a to 114c.

The liquid crystal panel 116 is sandwiched between the bezel set 112a to 112c and the frame set 114a to 114c. A reference numeral 113 represents an insulating layer configured to insulate a driving circuit board 115 (see FIG. 6) for driving the liquid crystal panel 116. The substantially box-shaped backlight chassis 122 has an opening on the front-surface side (on the light exit side and the liquid crystal panel 116 side).

The optical members 118 are provided on the front-surface side of the light guide plate 120. The optical members 118 include laminated layers of light diffuser sheets, prism sheets and reflecting type polarizing sheets as appropriate. The light guide plate reflection sheet 134a is provided on the rear-surface side of the light guide plate 120. Furthermore, the backlight chassis 122 houses a pair of cable holders 131, a pair of mounting members 119, a pair of LED units 150 and the light guide plate 120 in the backlight chassis 122. The LED units 150, the light guide plate 120 and the light guide plate reflection sheet 134a are supported each other by a rubber bushing 133. A power supply circuit board (not illustrated) supplying power to the LED units 150 and a protection cover 123 for protecting the power supply circuit board are mounted on the rear side of the backlight chassis 122. The pair of cable holders 131 is arranged in the short-side direction of the backlight chassis 122 and holds cables electrically connected between the LED units 150 and the power supply circuit board.

FIG. 6 illustrates a vertical sectional view of the backlight unit 124. As illustrated in FIG. 6, the backlight chassis 122 includes a bottom plate 122a having the bottom surface 122z thereon and side plates 122b and 122c, each of which rises shallowly from an outer edge of the corresponding side of the bottom plate 122a. The backlight chassis 122 supports at least the LED unit 150 and the light guide plate 120.

Furthermore, each of the mounting members 119 includes a bottom surface portion 119a and a side surface portion 119b that rises from one of outer edges of the long side of the bottom surface portion 119a. Each of the mounting members 119 is formed in an L-shape and provided in the direction along one of long sides of the backlight chassis 122. The bottom surface portions 119a of the mounting members 119 are fixed to the bottom plate 122a of the backlight chassis 122. The LED units 150 (an LED board 157) extend in the direction along respective long sides of the backlight chassis 122. The LED units 150 are fixed to the side surface portions 119b of the mounting members 119 such that the light exit sides of the LED units 150 face each other. Accordingly, the bottom plate 122a of the backlight chassis 122 supports the LED units 150 through the mounting members 119. The mounting members 119 dissipate heat generated in the LED units 150 outside the backlight unit 124 through the bottom plate 122a of the backlight chassis 122.

As illustrated in FIG. 5, the light guide plate 120 is provided between the pair of LED units 150. The frame set 114a to 114c and the backlight chassis 122 sandwich the LED units 150, the light guide plate 120 and the optical members 118. Furthermore, the frame set 114a to 114c and the backlight chassis 122 fix the light guide plate 120 and the optical members 118. The configuration of the light guide plate 120 that is same as that of the light guide plate 50 in first embodiment will not be explained.

As illustrated in FIG. 6, the driving circuit board 115 is provided on the front-surface side of the bottom frame 114b. The driving circuit board 115 is electrically connected to the display panel 116 to supply image data and various control signals that are necessary to display images with the display panel 116. Front reflection sheets 134b are provided on surfaces of the top frame 114a and the bottom frame 114b that face the LED units 150. The front reflection sheets 134b extend in the long-side direction of the light guide plate 120. Rear reflection sheets 134c are provided on a part of the bottom plate 122a of the backlight chassis 122 that faces the LED units 150. An edge part of the rear reflection sheet 134c is arranged closely to the light guide plate 120 and provided so as to overlap an edge part of the light guide plate reflection sheet 134a in a plan view.

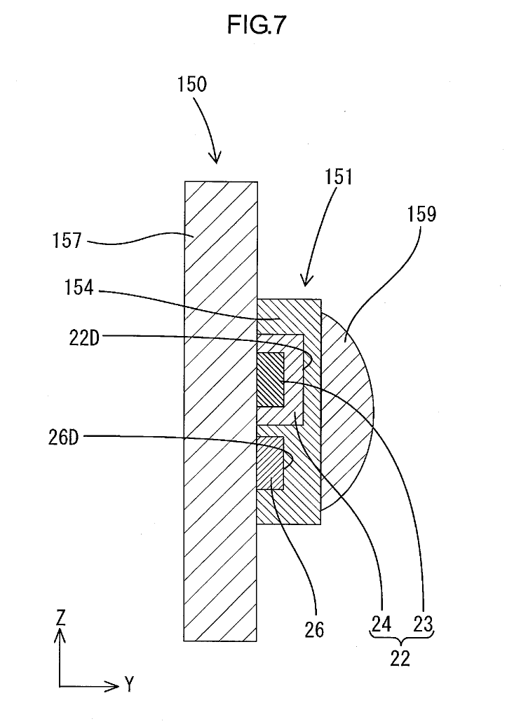

In the present embodiment, the LED unit 150 has a configuration different from that in the first embodiment. FIG. 7 illustrates a magnified view of a vicinity of the LED unit 150 in FIG. 6. As illustrated in FIG. 7, a light source set 151 in the LED unit 150 includes the first light source 22, the second light source 26 and a housing 154 that houses the first light source 22 and the second light source 26 therein. In the present embodiment, the first light source 22 and the second light source 26 are directly mounted on the LED board 157 without having the base 28 of the first embodiment.

A diffuser lens 159 is mounted on each of the light source sets 151. The diffuser lens 159 is provided so as to cover the light emitting surface 22D of the first light source 22 and the light emitting surface 26D of the second light source 26. The diffuser lens 159 is formed in a hemispherical shape, for example. A curved surface of the diffuser lens 159 faces the light entrance surface 50D of the light guide plate 50. With such a configuration, the diffuser lens 159 is configured to diffuse light exiting through the light emitting surfaces 22D and 26D.

In the present embodiment, the diffuser lens 159 diffuses light from the first light source 22 and the second light source 26, and accordingly, an illumination area illuminated with light exiting from each light source set 151 is increased. This causes the arrangement intervals between the light source sets 151 to be increased (namely, the total number of light source sets 151 is reduced) and achieves uniform brightness.

### Third Embodiment

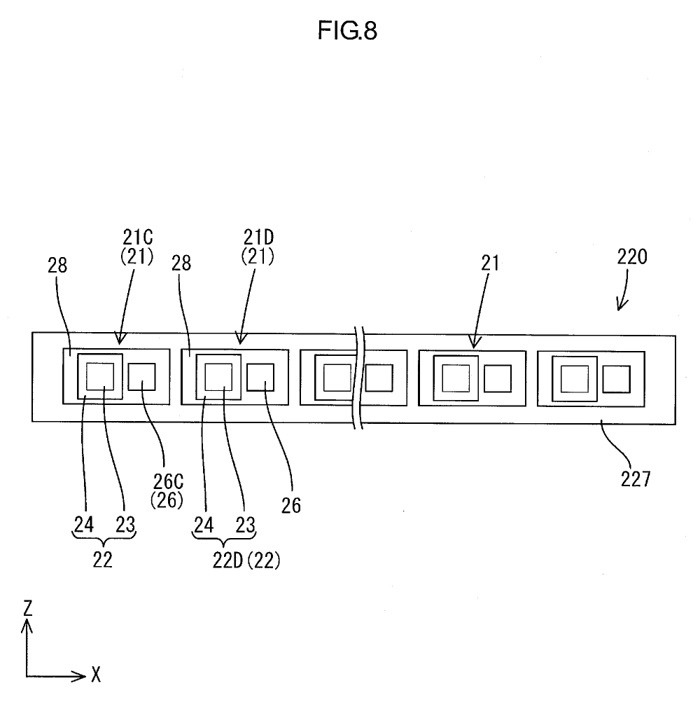

An LED unit 220 according to a third embodiment of the present invention will be explained with reference to FIG. 8. In the LED unit 220 of the present embodiment, an arrangement direction of the light source sets 21 is different from that of the first embodiment. In the present embodiment, the first light source 22 and the second light source 26 in each of the light source sets 21 are arranged in the same direction (X-axis direction) as the arrangement direction of the light source sets 21 on an LED board 227. With such an arrangement of the light source sets 21, a width of the LED board 227 (a length of the LED board 227 in the Z-axis direction) can be smaller than the widths of the LED boards 27 and 157.

In the present embodiment, in the two adjacent light source sets 21 (for example, 21C and 21D), the first light source 22 (22D) in one of the light source sets 21 (21D) and the second light source 26 (26C) in the other one of the light source sets 21 (21C) are arranged adjacent to each other in the X-axis direction (the arrangement direction of the two adjacent light source sets 21). In other words, the first light source 22 and the second light source 26 are alternately arranged in the X-axis direction in the two adjacent light source sets 21C and 21D. With such a configuration, the first light sources 22 (or the second light sources 26) are less likely to be arranged locally on the LED board 227, compared to a configuration where the first light sources 22 (or the second light sources 26) are arranged adjacent to each other. This results in reducing uneven brightness and color unevenness in light exiting from the LED unit 220.

### Other Embodiments

The present invention is not limited to the above embodiments described in the above description and the drawings. The following embodiments are also included in the technical scope of the present invention, for example.

(1) In the above embodiments, the first light source includes a blue LED chip and phosphors configured to emit light in red and green colors. However, the LED chip of the first light source may be configured to emit at least a single color of light of red, green or blue. Namely, the LED chip of the first light source may be configured to emit two or more colors (or mixture of two or more colors) of light among red, green and blue. The phosphors of the first light source may be configured to emit colors of light that are different from colors of light emitted by the first LED chip. The second light source may be an LED that is configured to emit at least a single color of light of cyan, magenta or yellow. Namely, the second light source may be an LED that is configured to emit two or more colors (or mixture of two or more colors) of light among cyan, magenta and yellow.

(2) In the second embodiment, the single diffuser lens 159 covers the light emitting surface 22D of the first light source 22 and the light emitting surface 26D of the second light source 26. However, each of the light emitting surface 22D of the first light source 22 and the light emitting surface 26D of the second light source 26 may be covered with an independent diffuser lens.

(3) The arrangement direction of the first light source and the second light source in a single light source set is not limited to the direction illustrated in the above embodiments (the X-axis direction or the Z-axis direction) but may be altered if necessary.

(4) The shape of the diffuser lens 159 is not limited to a hemispherical shape. The diffuser lens 159 may be formed in any shape as long as the diffuser lens 159 may diffuse light from the first light source or the second light source. For example, the diffuser lens 159 may be a cylindrical lens configured to diffuse light in a single direction.

(5) The configuration of the optical member 40 is not limited to the above embodiments. Types of the sheets and the number of each type of the sheets included in the optical member 40 may be altered if necessary.

(6) In the above embodiments, TFTs are used as switching components of the liquid crystal display device. However, the technology described above can be applied to liquid crystal display devices including switching components other than TFTs (e.g., thin film diode (TFD)). Moreover, the technology can be applied to not only color liquid crystal display devices but also black-and-white liquid crystal display devices.

(7) In the above embodiments, the liquid crystal display device including the liquid crystal panel as a display panel. The technology can be applied to display devices including other types of display components.

(8) In the above embodiments, the television receiver including the tuner is used. However, the technology can be applied to a display device without a tuner.

### EXPLANATION OF SYMBOLS

10, 110: liquid crystal display device (display device), 12, 116: liquid crystal panel (display panel), 15: housing member, 20, 150, 220: LED unit (light source unit), 21, 151: light source set, 21A, 21B: two adjacent light source sets, 22: first light source, 22A: first light source (first light source in one of the light source sets), 22D: light emitting surface of the first light source, 23: first LED chip, 24:resin material, 26: second light source, 26B: second light source (second light source in another one of the light source sets), 22D: light emitting surface of the second light source, 27, 157, 227: LED board (board), 34, 124: backlight unit (lighting device), 50, 120: light guide plate, 50A: light exit surface, 50D: Light entrance surface, 159: diffuser lens, TV: television receiver

1. A light source unit comprising:
a board; and
a plurality of light source sets arranged on the board and each of which including a first light source and a second light source,
the first light source including a first LED chip and a phosphor, the first LED chip being configured to emit at least a single color of light of red, green or blue, the phosphor being configured to be excited by the light from the first LED chip to emit light of a color that is different from the color of the light emitted from the first LED chip, and
the second light source being configured to emit at least a single color of light of cyan, magenta or yellow, wherein at least two of the light source sets that are adjacent to each other are arranged such that the first light source in one of the two light source sets and the second light source in another one of the two light source sets are arranged adjacent to each other in an arrangement direction in which the adjacent light source sets are arranged.

2. The light source unit according to claim 1, wherein the first light source and the second light source in each of the light source sets are arranged on the board in a direction that crosses the arrangement direction of the light source sets.

3. The light source unit according to claim 1, wherein:
the first light source is configured by sealing the first LED chip with a resin material; and
the phosphor is contained in the resin material in a dispersed manner.

4. The light source unit according to claim 1, wherein:
the first LED chip is a blue LED chip configured to emit blue light; and
the phosphor includes a red phosphor excited by light from the first LED chip to emit red light and a green phosphor excited by light from the first LED chip to emit green light.

5. The light source unit according to claim 4, wherein the red phosphor is a CASN phosphor.

6. The light source unit according to claim 4, wherein the green phosphor is a SiAlON-based phosphor.

7. The light source unit according to claim 4, wherein the green phosphor is a YAG-based phosphor.

8. The light source unit according to claim 1, further comprising a diffuser lens, wherein:
the first light source includes a light emitting surface;
the second light source includes a light emitting surface; and
the diffuser lens is provided so as to cover at least one of the light emitting surface of the first light source and the light emitting surface of the second light source and configured to diffuse light from at least the one of the light emitting surfaces thereof.

9. A lighting device comprising:
the light source unit according to claim 1; and
a housing member housing the light source unit.

10. The lighting device according to claim 9, further comprising a light guide plate including a light entrance surface and a light exit surface, the light entrance surface facing the light emitting surface of the first light source and the light emitting surface of the second light source,
wherein light exited from the light emitting surfaces of the light sources enters the light entrance surface and exits from the light exit surface.

11. A display device comprising:
the lighting device according to claim 9; and
a display panel configured to provide display using light from the lighting device.

12. The display device according to claim 11, wherein the display panel is a liquid crystal panel using liquid crystal.

13. A television receiver comprising the display device according to claim 11.
